(19) United States
(12) Patent Application Publication
(10) Pub. No.: US 2002/0083990 A1
(43) Pub. Date: Jul. 4, 2002

(54) Method and apparatus for repairing a pipeline

(76) Inventor: Philip L. Lundman, Fredonia, WI (US)

Correspondence Address: MICHAEL BEST & FRIEDRICH, LLP, 100 E WISCONSIN AVENUE, MILWAUKEE, WI, 53202, US

(21) Appl. No.: 09/754,839

(22) Filed: Jan. 4, 2001

(51) Int. Cl. F16L 55/16

(52) U.S. Cl. 138/98; 138/97

(57) ABSTRACT

The invention includes a method for repairing a pipe and including the acts of providing an inflatable packer which when deflated has a diameter smaller than the diameter of the pipe such that the uninflated packer can be pulled through the pipe, applying a repair material around the uninflated packer, moving the uninflated packer through the pipe to a position where the uninflated packer is housed in a section of the pipe to be lined and inflating the packer with fluid pressure to force the repair material against the inner surface of the section of the pipe to be lined.

### FIELD OF THE INVENTION

The invention relates to methods for repairing or relining of pipes and pipelines in situ and to inflatable plugs for use in plugging pipelines such as wastewater lines, water lines and gas lines.

### BACKGROUND OF THE INVENTION

Attention is directed to U.S. Pat. No. 5,901,752 illustrating an inflatable plug for use in sealing pipes and pipelines.

Attention is further directed to U.S. Pat. No. 4,565,222 and U.S. Pat. No. 5,353,842 also illustrating inflatable plug arrangements of the type for use in plugging or sealing a pipe or pipeline.

### SUMMARY OF THE INVENTION

The invention includes a method for repairing a pipe, the method comprising the acts of providing an inflatable packer which when deflated has a diameter smaller than the diameter of the pipe such that the uninflated packer can be pulled through the pipes.

A resin impregnated fabric material is wrapped around the uninflated packer and the uninflated packer is moved through the pipe to a position where the uninflated packer is housed in a section of the pipe to be lined

The packer is then inflated with fluid pressure to force the resin impregnated fabric material against the inner surface of the section of the pipe to be lined.

In a preferred form of the invention, the inflatable packer has an inflatable woven fabric layer and inflatable bladder within the fabric layer.

The method can further include forcing heated fluid through the inflated packer to heat the resin impregnated fabric to cause curing.

The invention also includes a method for repairing a pipe including the acts of positioning an inflatable packer within a section of pipeline to be repaired, forcing a flowable repair material between the exterior surface of the inflatable packer and the pipe, curing the flowable material, deflating the inflatable packer and moving the inflatable packer to a second position within the pipe.

### BRIEF DESCRIPTION OF THE DRAWINGS

FIG. 1 is an elevation view of an inflatable packer embodying the invention and being positioned in a pipe for repair of the pipe.

FIG. 2 is a view similar to FIG. 1 but showing the inflatable packer positioned with a repair sleeve inside of the break in the pipe.

FIG. 3 is a view similar to FIGS. 1 and 2 and illustrating the packer partially in cross section and inflated to press the repair material into place in the interior of the pipe.

FIG. 4 is a view similar to FIG. 2 but illustrating an alternative embodiment of the invention.

FIG. 5 is a view similar to FIG. 3 but showing the alternative embodiment of the invention illustrated in FIG. 4.

FIG. 6 is a view similar to FIG. 5 but showing the inflatable packer deflated and the repair material in place in the pipe.

### DESCRIPTION OF A PREFERRED EMBODIMENT

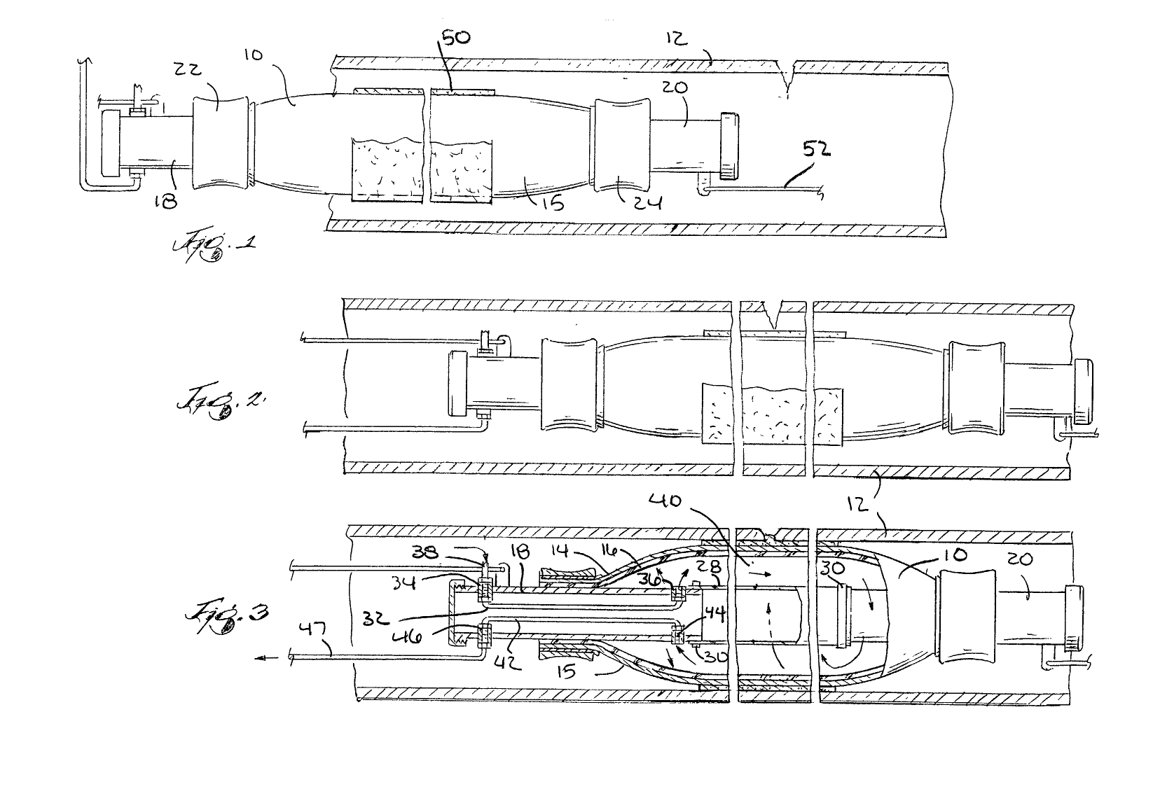

FIG. 1 illustrates an inflatable packer 10 embodying the invention and for use in repairing or providing a lining material in a pipe or pipeline 12. The pipe or pipeline can be a water supply pipe, gas pipe or pipeline, a wastewater line or drainage pipe or pipeline. While in the illustrated arrangement the pipe or pipeline 12 is shown oriented generally horizontally, the method and apparatus of the invention could be employed to repair or reline pipes or pipelines which are oriented vertically.

As shown in FIG. 3, the inflatable packer 10 includes an inflatable bag 5 comprised of one or more layers of flexible material. In the preferred form of the invention, at least one of the layers of material is a woven fabric layer 14 formed from inelastic fibers. A second inner layer 16 of material can be provided to provide a gas permeable bladder on the inside of the woven fabric material layer 14. The woven fabric material layer will function to provide protection for the bladder 16 to prevent wear, tearing or damage from sharp objects while also limiting the extent of inflation to thereby control the size and shape of the inflated packer 10. The inflated packer 10 also includes at its opposite ends tubes or pipes 18 and 20 supporting the opposite ends of the inflatable bag 15. In a preferred form of the invention, the pipes 18 and 20 are rigid steel pipes, and the ends of the inflatable bag 15 are formed of the layers of material 14 and 16 are wrapped around the pipes 18 and 20 and secured to the pipes in fluid tight relation by swaged metal collars or bands 22 and 24. The method of securing the ends of the inflatable bag around the pipe sections forming the ends of the packer is described more clearly in U.S. Pat. No. 5,901,752, which is incorporated herein by reference.

While in the illustrated arrangement, the inflatable packer 10 is shown as having pipe sections 18 and 20 at its opposite ends, in other applications a single elongated pipe could extend through the inflatable bag. The use of separate pipe sections at opposite ends of the inflatable packer provides flexibility and facilitates installation of the inflatable packer into a pipe or pipeline.

In a preferred form of the invention, the inflatable bag will be comprised of at least two layers of material, a layer of canvas or other in elastic, high strength fabric material 14 and the layer of material comprising a fluid tight membrane 16. The fluid tight membrane 16 can be comprised of rubber or other elastomeric products. The layer of canvas 14 provided on the outside of the fluid tight membrane 16 functions to limit the external diameter of the inflatable packer when it is inflated and limits the stretch and the maximum size of the fluid impermeable layer 16. Suitable materials for forming the inflatable bag are described in U.S. Pat. No. 5,901,752 and the subject matter of that patent is incorporated herein by reference. In the illustrated arrangement, the two pipe sections 18 and 20 at opposite ends of the packer are joined by a flexible tube 28. Bands 30 surround the opposite ends of the tube 28 and secure those ends to the pipe sections 18 and 20.

A tube 32 extends inside one of the pipe sections 18 and functions to provide fluid communication from a port 34 through the pipe wall to a second port 36. A fluid pressure tube 38can be connected to the port 34 such that fluid can be forced through the tube 32 and port 36 to the space 40 between the end of the pipe section and the interior of the inflatable bag 10. The bag can thus be pressurized to cause inflation or expansion of the bag as shown in FIG. 3.

A second tube 42 can also be provided internally of the pipe section and can extend from port 44 to port 46. The tube 42 can provide for selective exhaust of fluid from the space 40 inside the inflatable bag.

While the inflatable packer embodying the invention can be constructed of varying sizes depending upon the size of the pipe or pipeline to be repaired or relined, the packer can conveniently have a diameter which ranges from several inches to several feet and the inflatable packer can have a length of up to 50 feet or more.

In operation of the inflatable packer shown in FIG. 1, a packing or repair material 50 is wrapped around the uninflated inflatable packer 10. The packing or repair material 50 can include a felt material or other fabric or a composite material impregnated with a curable resin. The inflatable packer having the repair material wrapped around the uninflated packer is then pulled through the pipe or pipeline using a flexible tensile member 52 until the repair material 50 is positioned, as shown in FIG. 2, opposite the area of the pipeline to be repaired or relined. Fluid under pressure is then forced through the pipe or conduit 38 to inflate the packer 10 and to force the repair material 50 outwardly against the interior wall of the pipe or pipeline as shown in FIG. 3. The repair material 50 will be forced against the inner wall of the pipeline under a pressure substantially equal to the fluid pressure applied through the tubing 38. In a preferred form of the invention, the inflatable packer will have a maximum inflated diameter which is slightly greater than the inside diameter of the pipe and such that the inelastic fabric layer 14 will not prevent the fluid pressure from forcing the repair material 50 tightly against the inner wall of the pipe 12, but the inelastic fabric layer will restrict or limit expansion of the repair material 50 into the crack or hole in the wall of the pipe. Stated alternatively, the fabric material 14 will bridge the crack or hole in the pipe to prevent fluid pressure from extruding the repair material into the crack or hole in the pipe and otherwise reducing the effectiveness and integrity of the repair material.

In one form of the invention, the resin material used in repair or relining of the pipe can be a heat curable polymer. The resin can be cured by injecting steam or other heated gas or fluid through the port 34 to inflate the inflatable packer. The steam or other heated fluid can be forced into the inflatable packer through line 32 and be exhausted through port 46 and line 47 for a sufficient period of time to cure the resin material.

The inflated inflatable packer can then be deflated leaving the cured patch or repair material bonded to the interior surface of the pipe to form a finished repair or relining.

A pressure gauge can be provided in fluid line 38 to permit the operator to maintain suitable pressure in the inflatable bag for a sufficient period of time to achieve curing of the resin material.

While in the illustrated arrangement, the packer is shown as being used to repair a single discrete crack in the pipeline, in other applications after the first repair material is fixed in place in the pipe, the packer can be deflated and removed from the pipe. A second piece of resin impregnated material can be wrapped around the inflatable packer and then the inflatable packer can be repositioned in the pipeline at a second position to repair a second section of pipe.

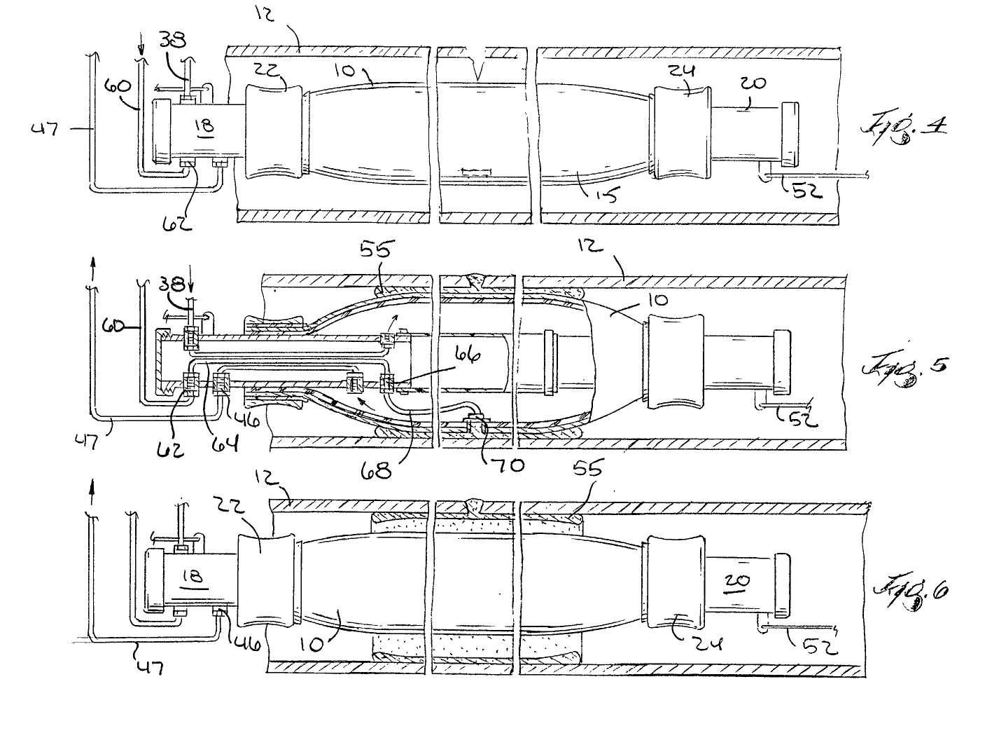

FIGS. 4-6 illustrate an alternative method and apparatus for repairing a pipe or pipeline using an inflatable packer embodying the invention. The inflatable packer illustrated in FIGS. 4-6 has a similar construction to that shown in FIGS. 1-3, but further includes a port extending through the material of the inflatable bag for use in injecting a flowable repair material into the space between the inflatable bag and the inner surface of the pipe. The repair material can be any flowable material which can cure to form a repair layer or interior surface of the pipe. For example, the repair material can be grout 55 or other cement based product or a curable resin or other polymer material. A supply tube 60 is connected to the port 62 and a tube 64 extends along the interior of the pipe section 18 to a port 66. A flexible tube 63 connect the port 66 and outlet 70.

In operation of the packer shown in FIGS. 4-6, the inflatable packer is positioned in the pipeline and pulled by a tensile member 52 such as a cable to a position where a repair is to be made in the pipe. The packer is then inflated by the application of gas pressure through the tube 38 as shown in FIG. 5. A flowable repair material 55 is then forced through the port 66 and opening 70 to fill a space between the outside wall of the inflatable packer and the inner wall of the pipe. The flowable repair material is injected at a pressure which is slightly higher than the inflation pressure applied to inflate the inflatable packer. The flowable material will then flow evenly to form a relatively thin layer of repair material between the packer and the inner wall of the pipe. If the repair material is a resin material, heated fluid can be forced through the packer to maintain the inflatable packer in inflated condition while also curing the heat curable resin material. Such heated fluid can comprise steam or other heated gases or liquids.

Once the repair material has cured in place, the inflatable packer can then be deflated leaving the cured repair material in place on the inner surface of the pipe or pipeline. The inflatable packer can then be pulled along the pipe to a second position where the inflatable packer is again inflated. Repair material can then be injected between the inflated packer and the pipeline and the curing process is then repeated. This process can be repeated continually to form a continuous, uninterrupted lining extending along the entire length of the pipe. Inflatable packers for use in the application illustrated in FIGS. 4-6 can conveniently have a length of 10 feet and maybe as much as 50 feet in length. The inflatable packers can also be constructed to be larger in diameter at their opposite ends than at the middle section of the bag. This arrangement will permit the ends of the bag to form a seal with the inner wall of the pipeline.

1. A method for repairing a pipe, the method comprising the acts of:
providing an inflatable packer, the inflatable packer when deflated having a diameter smaller than the diameter of the pipe such that the uninflated packer can be pulled through the pipe;
applying a resign impregnated fabric material around the uninflated packer;
moving the uninflated packer through the pipe to a position where the uninflated packer is housed in a section of the pipe to be lined; and
inflating the packer with fluid pressure.

2. A method as set forth in claim 1, wherein the inflatable packer when inflated has a diameter approximating the interior diameter of the pipe.

3. A method as set forth in claim 1, wherein the act of providing an inflatable packer includes providing an inflatable packer having an inflatable woven fabric layer and inflatable bladder within the fabric layer.

4. A method for repairing a pipe as set forth in claim 1, wherein the step of inflating includes forcing the resin impregnated fabric material against the inner surface of the section of the pipe to be lined.

5. A method for repairing a pipe as set forth in claim 1, and further including the act of forcing heated fluid through the inflated packer to heat the resin impregnated fabric to cause curing.

6. A method for repairing a pipe including the acts of:
positioning an inflatable packer within a section of pipeline to be repaired;
forcing a flowable repair material between the exterior surface of the inflatable packer and the pipe;
curing the flowable material;
deflating the inflatable packer; and
moving the inflatable packer to a second position within the pipe.

7. A method as set forth in claim 6, further including the step of providing an inflatable mandrill including a port which permits liquid to be forced between the exterior surface of the mandrill and the interior of the pipe.

8. A method as set forth in claim 7, and further including the step of inflating the inflatable mandrill in the pipe before forcing the repair liquid between the exterior surface of the inflatable mandrill and the pipe.
